(19) United States
(12) Patent Application Publication
(10) Pub. No.: US 2010/0142644 A1
(43) Pub. Date: Jun. 10, 2010

(54) Hierarchical Modulation

(76) Inventors: Hong Jiang, Warren, NJ (US); Paul A. Wilford, Bernardsville, NJ (US); Stephen A. Wilkus, Monmouth, NJ (US)

Correspondence Address: HARNESS, DICKEY & PIERCE, P.L.C., P.O. BOX 8910, RESTON, VA, 20195, US

(21) Appl. No.: 12/314,378

(22) Filed: Dec. 9, 2008

(51) Int. Cl. H04L 27/36

(52) U.S. Cl. 375/298

(57) ABSTRACT

A method for modulating first and second bit streams in a communications network that supports at least one of a binary phase-shift keying (BPSK), a quadrature phase-shift keying (QPSK) or a quadrature amplitude modulation (QAM) constellation uses hierarchical modulation. A hierarchical modulation parameter that varies within the network is set. The first bit stream is modulated based on a first constellation of the hierarchical modulation and the hierarchical modulation parameter. The second bit stream is modulated based on a second constellation in the first constellation.

### BACKGROUND OF THE INVENTION

In a conventional wireless system, there is often a need to provide global and local content. As is well-known, a single frequency network (SFN) is a broadcast network in which several transmitters simultaneously transmit the same signal over the same frequency channel. One type of conventional SFN is known as a hybrid satellite and terrestrial SFN. The satellites are generally used to transmit a signal over a wide area. The terrestrial transmitters are generally used to supplement the satellite signal in areas where the satellite signal is blocked. The same waveform and frequency band are broadcasted by the satellites and terrestrial transmitters.

However, it is difficult to provide local content to a service area that is covered by a satellite because the terrestrial transmitters and the satellite broadcast the same waveform. Thus, local content is often broadcasted to the entire network, even to areas with no interest in the local content. Examples of local content include advertising, traffic, news and weather.

In order to efficiently transmit local and global content, hierarchical modulation is used. An example hybrid SFN that utilizes hierarchical modulation is defined in the Digital Video Broadcasting-Satellite service to Handhelds (DVB-SH) standard “Framing Structure, Channel Coding and Modulation for Satellite Services to Handheld devices (SH) below 3 GHz.” DVB Document A111, Rev. 1, July 2007. Other types of DVB standards include DVB-T and DVB-H.

An example of a communications network that supports a binary phase-shift keying (BPSK), a quadrature phase-shift keying (QPSK) and/or a quadrature amplitude modulation (QAM) constellation, such as a DVB-SH network, is illustrated in FIG. 1. A communications network 100 includes a satellite 110 which broadcasts signals to clusters 120 and 130. The clusters 120 and 130 may include pluralities of terrestrial transmitters 125 and 135, respectively.

As shown, the satellite 110 transmits global content to the receivers R in the clusters 120 and 130. Furthermore, the satellite transmits the global content to the pluralities of terrestrial transmitters 125 and 135. The pluralities of terrestrial transmitters 125 and 135 then transmit to the receivers R only the global content from the satellite 110 or both global and local content. As stated before, the pluralities of terrestrial transmitters 125 and 135 are generally used to supplement the satellite signal in areas where the signal from the satellite 110 is blocked.

Each of the satellite 110, terrestrial transmitters 125 and 135 and receivers R utilize the same hierarchical modulation/demodulation. The conventional hierarchical modulation/demodulation used in the DVB communications network is shown in FIG. 2A.

FIG. 2A illustrates the 16 symbol quadrature amplitude modulation (16-QAM) specified by the DVB standards.

Global bits and local bits are modulated using a hierarchical modulation 200 illustrated in FIG. 2A. As shown, the global bits are modulated with a high priority (HP) constellation 205 that is separated by the quadrants. While only one HP constellation 205 separated by a quadrant is depicted by a reference character, it should be understood that there are four HP constellations. The local bits are modulated by a low priority (LP) constellation 210 within the HP constellation. Furthermore, while only one LP constellation 210 within each HP constellation is depicted by a reference character, it should be understood that there are four LP constellations within each HP constellation. Thus, the global bits are a high priority (HP) bit stream and the local bits are a low priority (LP) bit stream.

A hierarchical modulation parameter α, is utilized in hierarchical modulations. The hierarchical modulation parameter α signifies the hierarchical distance, as shown in FIG. 2A. The definition of the hierarchical modulation parameter α can be found in DVB Document A111, Rev. 1, July 2007. α is the minimum distance separating two constellation points carrying different HP-bit values divided by the minimum distance separating any two constellation points. In a uniform 16-QAM, α equals 1. Furthermore, the distance between each point within the same quadrant is 2. Different values of α provide the hierarchical modulation with different performance characteristics.

However, conventional DVB systems allow only one value of α to be used for all transmitters in a network. Furthermore, the value of α is limited to 3 values, 1, 2 or 4. These limitations severely reduce the efficiency of a network, since different transmitters in a network may work better with different values of α.

### SUMMARY OF INVENTION

Example embodiments provide methods and networks to transmit and receive signals using a hierarchical modulation parameter that varies within the network. The hierarchical modulation parameter is not limited to a known prescribed set of values.

One example embodiment provides a method of modulating first and second bit streams in a communications network that supports at least one of BPSK, QPSK or QAM constellation. The method includes setting a hierarchical modulation parameter that can vary within the network. The hierarchical modulation parameter is not limited to a known prescribed set of values. The first bit stream is modulated based on a first constellation and the hierarchical modulation parameter and the second bit stream is modulated based on a second constellation in the first constellation.

Another example embodiment provides a method of receiving a signal in a communications network that supports at least one of BPSK, QPSK or QAM constellation. The method includes determining a hierarchical modulation parameter that can vary within the network. The signal is demodulated into first and second bit streams. Demodulating the first bit stream is based on a first constellation and the hierarchical modulation parameter. Demodulating the second bit stream is based on a second constellation in the first constellation.

One example embodiment provides a communications network that supports at least one of BPSK, QPSK or QAM constellation. The communications network includes a transmitter configured to modulate first and second bit streams into a signal using a hierarchical modulation parameter that can vary within the network. The hierarchical modulation parameter is not limited to a known prescribed set of values. The communications network also includes a receiver configured to receive the signal and demodulate the signal into first and second bit streams using the hierarchical modulation parameter.

### BRIEF SUMMARY OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an example of a communications network;

FIG. 2 illustrates a conventional hierarchical modulation in a DVB-SH communications network;

FIGS. 3A-3C illustrate hierarchical modulations/demodulations according to an example embodiment;

FIGS. 4A-4B illustrate hierarchical modulations/demodulations according to another example embodiment;

FIG. 5 illustrates a modified pilot according to an example embodiment;

FIG. 6A illustrates a Transmission Parameter Signaling (TPS) format according to a DVB standard;

FIG. 6B illustrates a TPS format according to an example embodiment;

FIG. 7 illustrates modifying a TPS bit according to an example embodiment;

FIG. 8A illustrates a hierarchical receiver according to an example embodiment; and

FIG. 8B illustrates a hierarchical transmitter according to an example embodiment.

### DETAILED DESCRIPTION OF THE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “buffer” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used herein, the term “receiver” may be considered synonymous to, and may hereafter be occasionally referred to, as a client, mobile, mobile unit, mobile station, mobile user, user equipment (UE), subscriber, user, remote station, access terminal, receiver, etc., and may describe a remote user of wireless resources in a wireless communication network.

Example embodiments are directed to methods and networks supporting at least one of BPSK, QPSK or QAM constellation that allow different transmitters in a network to be able to choose different values of a hierarchical modulation parameter, β. In the example embodiments, the hierarchical modulation parameter β is used instead of the hierarchical modulation parameter α. Like the hierarchical modulation parameter α, the hierarchical modulation parameter β is still based on distances between constellation points.

While some example embodiments are discussed with reference to DVB standards, it should be understood that the example embodiments may be implemented in any network that supports at least one of PBSK, QPSK or QAM constellation.

The hierarchical modulation parameter β may be a value that is selected based on conditions in a cluster in an entire network, instead of prescribed values as in the conventional DVB systems. The hierarchical modulation parameter β is transmitted implicitly by modifying pilots defined in the DVB standards. The value of the hierarchical modulation parameter β is not explicitly transmitted in the bit stream, unlike the conventional DVB systems. Instead, the value of the hierarchical modulation parameter β is implicitly transmitted, thereby avoiding the limitation of one hierarchical modulation parameter β value to be used in the entire network, or the limitation of the hierarchical modulation parameter β to a known prescribed set of values. Since the value of the hierarchical modulation parameter β is transmitted implicitly, the value of the hierarchical modulation parameter β can be any arbitrary value.

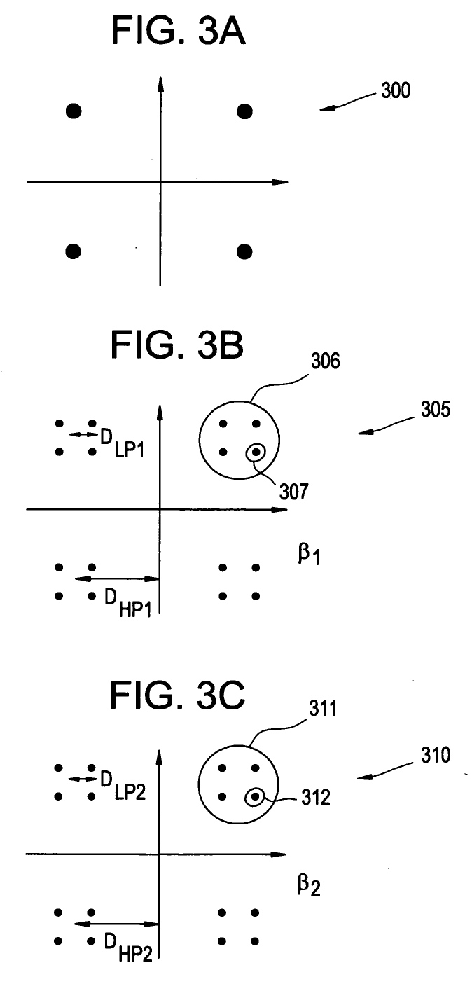

FIGS. 3A-3C illustrate hierarchical modulations/demodulations according to an example embodiment. FIG. 3A illustrates a hierarchical modulation 300 that is used in the satellite 110. Shown in FIG. 3A, is a quadrature phase-shift keying (QPSK) constellation. Therefore, hierarchical modulation does not need to be used at the satellite 110. QPSK is used to transmit global content from the satellite 110 to all of the receivers R.

FIGS. 3B and 3C illustrate example hierarchical modulations/demodulations 305 and 310, for the pluralities of terrestrial transmitters 125 and 135, respectively, when both global and local content are being transmitted. While the discussion references global and local content, it should be understood that the example embodiments may used with any first and second bit streams, regardless of whether the first and second bit streams represent global and local content, respectively. In some example embodiments, global content may used interchangeably with HP and local content may be used interchangeably with LP, however, the terms should not be limited thereto.

When only one bit stream, for example, global content, is being transmitted, the hierarchical modulations/demodulations used in the pluralities of terrestrial transmitters 125 and 135 are substantially similar to the QPSK constellation used in the satellite 110.

As shown, the pluralities of terrestrial transmitters 125 and 135 use a 4/16-QAM hierarchical modulation 305 and 310, respectively, when providing both global and local content. Furthermore, the 4/16-QAM modulation 305 for the plurality of terrestrial transmitters 125 uses a hierarchical modulation parameter β₁ whereas the 4/16-QAM modulation 310 for the plurality of terrestrial transmitters 135 uses a hierarchical modulation parameter β₂. In a 4/16-QAM hierarchical modulation the hierarchical modulation parameter β is calculated as follows:

βₙ=D_{LPn}/D_{HPn} (1)

wherein D_{HPn} is the distance between an axis to the closest constellation point in a first constellation for a particular modulation and D_{LPn} is half of a distance between two closest constellation points in a second constellation for the particular modulation. The first and second constellations may be high and low priority constellations, respectively. Furthermore, since 4/16-QAM modulation is supported by DVB, the hierarchical modulation parameter β can be related to the hierarchical modulation parameter α as follows:

βn=1/(αₙ+1) (2)

Each of the hierarchical modulation parameters β₁ and β₂ is chosen based on the desired error characteristics of the clusters 120 and 130. Moreover, the hierarchical modulation parameters β₁ and β₂ are chosen based on the desired local and global content. A large hierarchical modulation parameter value β will reduce the reliability of the global content, but the local content will be noisier. A small hierarchical modulation parameter value β will increase the reliability of the local content. One of ordinary skill in the art would understand that the hierarchical modulation parameter value β may be selected based on design or may be empirically determined. Generally, hierarchical modulation parameters β₁ and β₂ are chosen so the global and local bits have the same bit-error-rate (BER) performance.

The transmitters within a same cluster, in which the signals may be overlapping, use the same value for the hierarchical modulation parameter β. Transmitters from different clusters, where signals do not overlap, may use different values of the hierarchical modulation parameter β. For example, the plurality of transmitters 125 use the hierarchical modulation parameter β₁, and the plurality of transmitters 135 use the hierarchical modulation parameter β₂. The hierarchical modulation parameters β₁ and β₂ may be different if the clusters 120 and 130 do not overlap.

As shown in FIG. 3B, the global bits being transmitted by the plurality of terrestrial transmitters 125 are modulated with a first constellation 306 that is separated by quadrants and the local bits are modulated by second constellation 307 within each first constellation 306. The first constellation 306 may be an HP constellation and the second constellation 307 may be an LP constellation, but should not be limited thereto.

While only one first constellation 306 separated by quadrants is depicted by a reference character, it should be understood that there are four first constellations 306. Furthermore, while only one second constellation 307 within each first constellation 306 is depicted by a reference character, it should be understood that there are four second constellations within first constellation. Thus, the global bits are a first bit stream and the local bits are a second bit stream.

FIG. 3C illustrates the modulation for the plurality of terrestrial transmitters 135 having first constellations 311 and second constellations 312. A similar modulation process is used for the global bits and the local bits that are transmitted by the plurality of terrestrial transmitters 135. Therefore, for the sake of clarity and brevity, the modulation process for the global bits transmitted by the plurality of terrestrial transmitters 135 will not be discussed.

Using the 4/16-QAM hierarchical modulation, both the global bit stream and the local bit stream are modulated with QPSK.

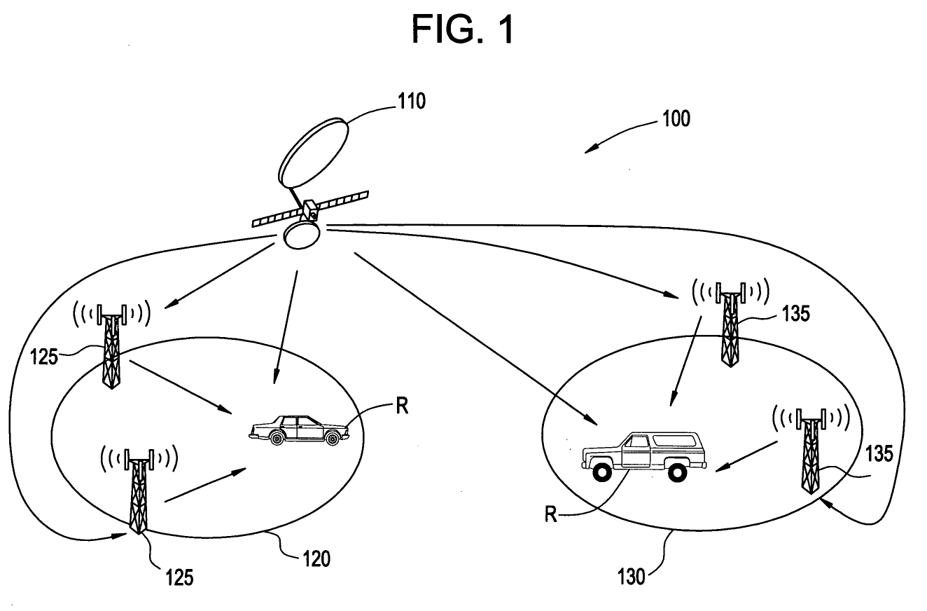

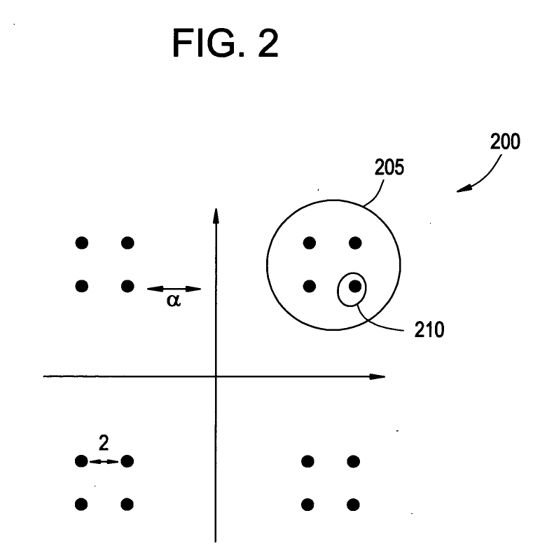

While only two clusters 120 and 130 are described and shown in the network of FIG. 1, it should be understood that the example embodiment should not be limited thereto. For example, a communications network according to an example embodiment may include additional clusters, each additional cluster with a hierarchical modulation/demodulation having a possible different hierarchical modulation parameter β value.

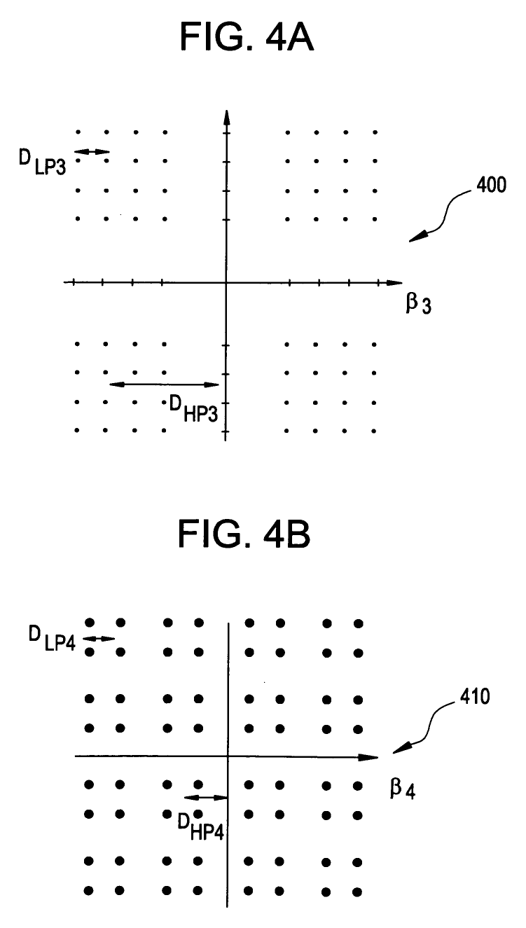

FIGS. 4A and 4B illustrate other example hierarchical modulation/demodulations that may be used by the plurality of terrestrial transmitters 125 and/or the plurality of terrestrial transmitters 135. FIG. 4A depicts a 4/64-QAM hierarchical modulation/demodulation 400. As shown, the 4/64-QAM hierarchical modulation 400 includes a hierarchical modulation parameter β₃ that equals D_{LP3} divided by D_{HP3}. In the 4/64-QAM hierarchical modulation 400, the global bit stream is modulated using QPSK and the local bit stream is modulated using 16-QAM. Since 4/64-QAM hierarchical modulation may be supported by DVB-SH, the hierarchical modulation parameter β is based on the hierarchical modulation parameter α as follows:

Bₙ=1/(αₙ+3) (3)

FIG. 4B depicts a 16/64-QAM hierarchical modulation/demodulation 410. As shown, the 16/64-QAM hierarchical modulation 410 includes a hierarchical modulation parameter β₄. In the 16/64-QAM hierarchical modulation 410, the global bit stream is modulated using 16-QAM and the local bit stream is modulated using QPSK. While the 4/64-QAM hierarchical modulation 410 includes the hierarchical modulation parameter β₄, the second hierarchical modulation parameter β₄ is not based on a α value because the 16/64-QAM hierarchical modulation 410 is not allowed in the current DVB standard.

In conventional DVB-SH communications networks, the value of α is transmitted explicitly using Transmission Parameter Signaling (TPS) signal bits. However, in example embodiments the value of the hierarchical modulation parameter β, may be embedded in a modulation by using pilots in DVB-SH OFDM symbols. Modulating the hierarchical modulation parameter β in the pilot, allows the hierarchical modulation parameter β to vary among the clusters 120 and 130 and be a non-integer positive number greater than or equal to zero.

The pilots are generally a pre-specified sequence that a receiver looks for to determine various communication factors such as channel estimation, frequency synchronization and frame synchronization. The pilots in DVB standards are binary phase-shift keying (BPSK) modulated.

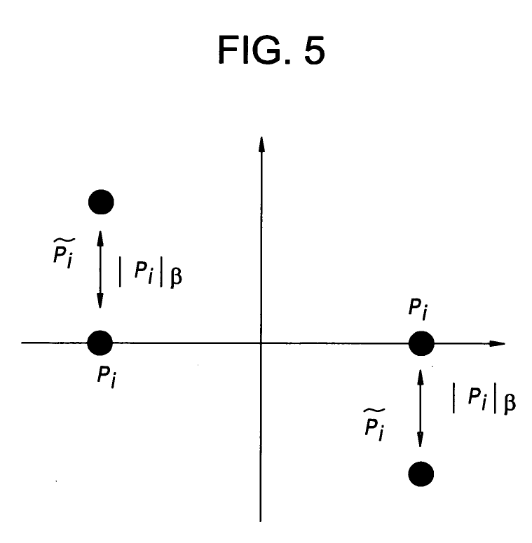

In the example embodiments, the pilots are modified and modulated as illustrated in FIG. 5. The pilots in the existing DVB standard will be modified as follows:

\tilde{P}ᵢ=Pᵢ+j(−1)β, =0,1,2, (4)

wherein \tilde{P}ᵢ is the modified pilot signal, Pᵢ is the pilot in the existing DVB standard, i is the bit number and j=\sqrt{−1}. The distance between the modified pilot Pi and the pilot in the existing DVB standard Pᵢ is half of the distance between two constellation points. Since the hierarchical modulation parameter β can be determined based on the distance between two constellation points, the modified pilot \tilde{P}ᵢ allows a receiver to detect hierarchical information.

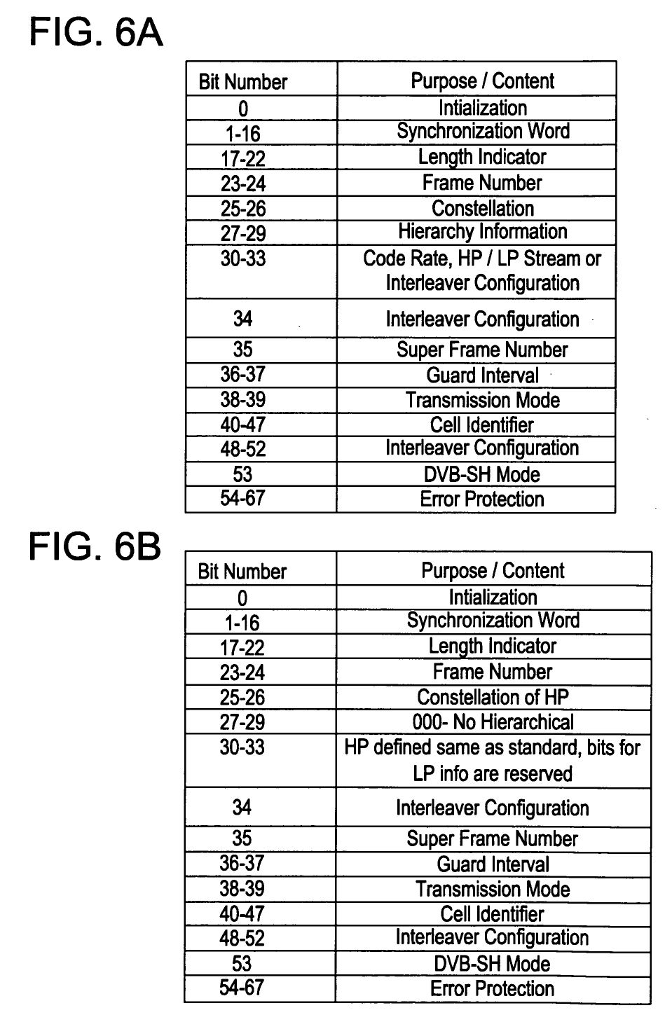

As is well know, TPS signals are used in DVB communication networks to transmit a constellation size and codes rates. The TPS format used in DVB communication networks is shown in FIG. 6A. The table can also be found on table 5.29 of DVB Document A111, Rev. 1, July 2007.

In the example embodiments, the TPS signal format used in the DVB-SH standard is changed. More specifically, bit numbers 25-33 are changed. Bits 25-26 in the TPS signal format represent the constellation, bits 27-29 represent the hierarchy information and bits 30-33 represent the code rate, HP/LP stream or interleaver configuration.

As shown in FIG. 6B, the TPS bits 25-33 in the changed signal format do not specify hierarchical information and they do not specify LP code rate. The bits are either ignored by receivers R, in which case, each of the pluralities of terrestrial transmitters 125 and 135 can transmit anything in other bit positions, or the bits can be reserved for other purposes. As indicated above, the hierarchical information is modulated in the pilots and, therefore, hierarchical information in the changed TPS signal format is not necessary.

As illustrated in FIG. 6A, the TPS format in the DVB standard includes a constellation parameter represented by bits 25-26. When no hierarchical modulation is used, the constellation parameter in the example embodiments remains the same as the DVB standard. However, when hierarchical modulation is used, the constellation parameter in the example embodiments only indicates the constellation size of the HP modulation, as shown in bits 25-26 of FIG. 6B. When hierarchical modulation is used, the constellation parameter in the TPS signal according to an example embodiment indicates the size of the HP constellation in bits 25-26 (for example, QPSK or 16-QAM). Thus, the bits in the changed TPS format do not specify hierarchical information, the LP constellation size or a LP code rate.

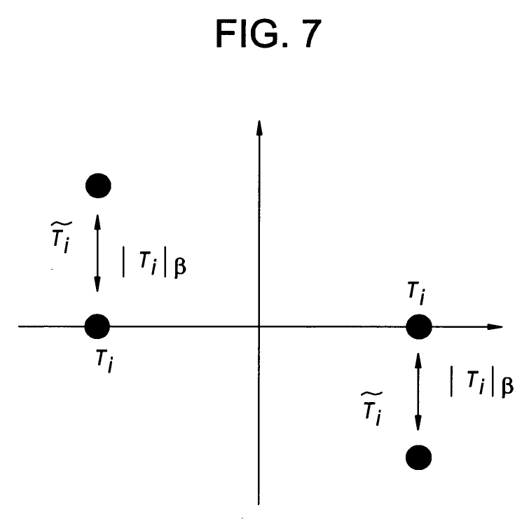

In the example embodiments, the TPS signals are modified as illustrated in FIG. 7. The TPS signal according to example embodiments is modified and differential phase-shift keying (DPSK) modulated as follows:

\tilde{T}ᵢ=Tᵢ+jTᵢ^{LP}|Tᵢ|β, i=0,1,2, (5)

wherein \tilde{T}ᵢ is the modified TPS bit, Tᵢ is the original TPS bit in the TPS signal according to example embodiments, i is the bit number, j=\sqrt{−1} and T₁^{LP} are DBPSK bits containing the second constellation size of the LP bit stream and the code rate of the LP bit stream.

The modified pilots, as shown in FIG. 5 are used for receivers R to determine whether the received signal is hierarchically modulated. If the received signal is hierarchically modulated, the receivers R are able to determine the value of the hierarchical modulation parameter β based on the modified pilot. When no hierarchical modulation is detected, only the QPSK signal will be demodulated.

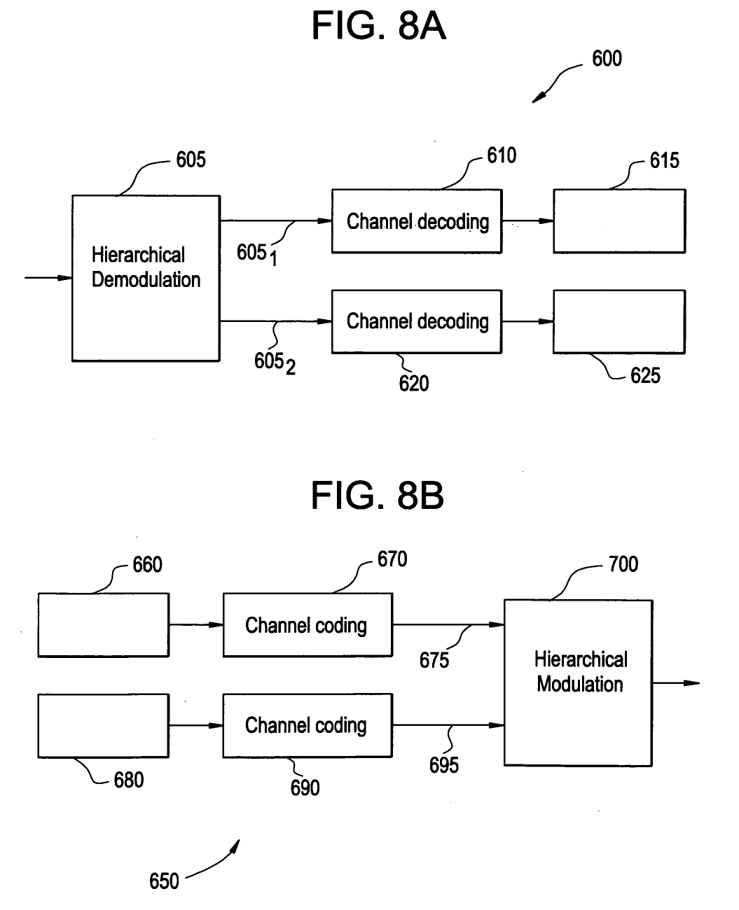

FIG. 8A illustrates an example receiver for receiving a signal. As shown, a receiver 600 includes a hierarchical demodulator 605 and channel decoders 610 and 620. When a signal is received, the demodulator 605 demodulates the signal into a first bit stream 605₁ and a second bit stream 605₂. The first bit stream 605₁ is decoded by the channel decoder 610 and output as global content 615. The second bit stream 605₂ is decoded by the channel decoder 620 and output as local content 625.

FIG. 8B illustrates a hierarchical transmitter 650 that is used for transmitting a signal. As shown, global content 660 is supplied to a channel coder 670 where the global content 660 is coded into a first, bit stream 675. The first bit stream 675 is then input to the hierarchical modulator 700. Local content 680 is supplied to a channel coder 690 where the local content 680 is coded into a second bit stream 695. The second bit stream 695 is then input to the hierarchical modulator 700. The hierarchical modulator 700 then modulates the first bit stream 675 and the second bit stream 695 in accordance with any hierarchical modulation technique described in the example embodiments.

Example embodiments may be implemented in any communications network that supports at least one of a BPSK, a QPSK or a QAM constellation, for example, a DVB-SH single frequency network. The hierarchical modulation parameter β allows a terrestrial transmitter in the network the flexibility of using a β value that best fits the needs of a cluster where the terrestrial transmitter is located.

The invention being thus described, it will be obvious that the same may be varied in many ways. Such variations are not to be regarded as a departure from the invention, and all such modifications are intended to be included within the scope of the invention.

We claim:

1. A method of modulating first and second bit streams in a communications network that supports at least one of a binary phase-shift keying (BPSK), a quadrature phase-shift keying (QPSK) or a quadrature amplitude modulation (QAM) constellation, the method comprising:
setting a hierarchical modulation parameter, the hierarchical modulation parameter being a value that can vary within the network;
modulating the first bit stream based on a first constellation and the hierarchical modulation parameter; and
modulating the second bit stream based on a second constellation in the first constellation.

2. The method of claim 1, wherein the hierarchical modulation parameter is a value greater than zero.

3. The method of claim 2, wherein the setting step sets the hierarchical modulation parameter based on a distance between an axis to a closest constellation point in the first constellation.

4. The method of claim 3, wherein the setting step sets the hierarchical modulation parameter further based on half of a distance between two closest constellation points in the second constellation.

5. The method of claim 2, wherein bits in the first bit stream are global content and bits in the second bit stream are local content.

6. The method of claim 1, further comprising:
embedding the hierarchical modulation parameter in a pilot.

7. The method of claim 6, the hierarchical modulation parameter is embedded according to the following equation:
\tilde{P}ᵢ=Pᵢ+j(−1)ⁱ|Pᵢ|β
wherein \tilde{P}ᵢ is the pilot with the embedded hierarchical modulation parameter, Pᵢ is the pilot without the hierarchical modulation parameter, j=\sqrt{−1} and β is the hierarchical modulation parameter.

8. The method of claim 1, wherein the setting step includes modifying a Transmission Parameter Signaling (TPS) bit stream to indicate a second constellation size.

9. The method of claim 1, further comprising:
transmitting the modulated first bit stream and the modulated second bit stream as a signal.

10. A computer readable medium comprising:
a code segment instructing a computer to perform the method of claim 1.

11. A method of receiving a signal in a communications network that supports at least one of a binary phase-shift keying (BPSK), a quadrature phase-shift keying (QPSK) or a quadrature amplitude modulation (QAM) constellation, the method comprising:
determining a hierarchical modulation parameter, the hierarchical modulation parameter being a value that can vary within the network;
demodulating the signal into first and second bit streams, the signal being demodulated into the first bit stream based on a first constellation and the hierarchical modulation parameter and the signal being demodulated into the second bit stream based on a second constellation in the first constellation.

12. The method of claim 11, wherein the hierarchical modulation parameter is a value greater than zero.

13. The method of claim 11, wherein the hierarchical modulation parameter is based on a distance between an axis to a closest constellation point in the first constellation.

14. The method of claim 13, wherein the hierarchical modulation parameter is further based on half of a distance between two closest constellation points in the second constellation.

15. The method of claim 11, wherein bits in the first bit stream are global content and bits in the second bit stream are local content.

16. The method of claim 11, wherein the determining a hierarchical modulation parameter step includes detecting the hierarchical modulation parameter in a pilot.

17. The method of claim 16, wherein the hierarchical modulation parameter is determined based on the following equation:
\tilde{P}ᵢ=Pᵢ+j(−1)ⁱ|Pᵢ|β
wherein \tilde{P}ᵢ is the pilot with the hierarchical modulation parameter, Pᵢ is the pilot without the hierarchical modulation parameter, j=\sqrt{−1} and β is the hierarchical modulation parameter.

18. The method of claim 11, wherein the determining a hierarchical modulation parameter step includes detecting a modified Transmission Parameter Signaling (TPS) signal that indicates a second constellation size.

19. A computer readable medium comprising:
a code segment instructing a computer to perform the method of claim 11.

20. A communications network that supports at least one of a binary phase-shift keying (BPSK), a quadrature phase-shift keying (QPSK) or a quadrature amplitude modulation (QAM) constellation, the communications network comprising:
a first transmitter configured to modulate first and second bit streams into a first signal using a first hierarchical modulation parameter and transmit the first signal to a receiver; and
a second transmitter configured to modulate third and fourth bit streams into a second signal using a second hierarchical modulation parameter and transmit the second signal to the receiver, the first signal and the second signal being transmitted at the same frequency.
